(19) United States
(12) Patent Application Publication
(10) Pub. No.: US 2003/0041045 A1
(43) Pub. Date: Feb. 27, 2003

(54) Method of implementing electronic name card and system thereof

(76) Inventor: Way Sun, Shanghai (CN)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/738,479

(22) Filed: Dec. 15, 2000

(30) Foreign Application Priority Data
Jul. 5, 2000 (CN) 00109767.9

(51) Int. Cl. G06F 17/30; G06K 19/06

(52) U.S. Cl. 707/1; 707/104.1; 707/9; 235/492

(57) ABSTRACT

This invention discloses a method and its system for implementing electronic name card. With database in telecommunication, the method establishes virtual electronic name card, which is a summation of user's personal information marked by user's ID. The system is composed of a central transaction-processing server and several local transaction processing servers. The central transaction-processing server links with central database system, and the local transaction-processing server with local database system. The central transaction processing server connects with the local transaction processing server through the computer network, while the public telecommunication network is connected with the ENC system through the local transaction processing server. A user can dial a special access number to request the electronic name card services including query, modification, exchange, and fast call.

### FIELD OF THE INVENTION

The present invention relates generally to the technical field of information management and exchange, especially to a method for establishing, managing and exchanging personal information using the current communications network, and a system for implementing the method.

### BACKGROUND OF THE INVENTION

When doing business, most of people used to get the business identification and personal information about the traders by exchanging the business cards between each other. In case of no business card, the information about the other side is written in a notebook. This, however, will bring about a lot of inconvenience, such as

a) if there are too many business cards (names), it is inconvenient to do query and manage the cards book (address book);

b) many cards (records) would be invalid resulting from the changes, e.g., working place, of the personal status;

c) the cards book (address book) is not portable, especially when user wants to make contact with somebody in office or at home or in outdoor situation, the traditional card case or address book is extremely inconvenient;

d) in case that the address book or card case lost, the user would suffer great loss, because it is not easy to backup the business card.

Although there are some other ways of making electronic address list, such as computer, PDA etc, they still have the following limitations:

a) to establish the list, it needs user's a lot of manual inputs, which will be tedious, time-consuming and inconvenient;

b) when the information about the telephone number and address of the opposite side changes, the user has to update the address list manually;

c) various kinds of application programs, such as Word Processing Program, Fax, Mail, Browser etc, have their own address list modules that are independent, while the information needed by users is often stored in different programs so that it is hard to manage and inquire.

### SUMMARY OF THE INVENTION

The objective of the invention is to provide a method for establishing virtual electronic address list, i.e. electronic name card and a system to implement the method in the current telecommunications network, so that users can establish and manage his own electronic name card without tedious input work. Users need to do nothing but dial a specific access code to make query, modification, update, exchange and telephone call.

The technical scheme achieving objectives of the invention is as follows:

A method implementing electronic name card service in telecommunications system is by means of database. It establishes virtual electronic name card in telecommunication system that includes a summation of users' personal information marked by user's ID. A User can dial a settled access number to request the electronic name card services including query, modification, exchange, and fast call.

The establishing procedure mentioned above is implemented by user's registration and applied for the service of electronic name card. It includes the steps of: a user fills in his personal information on registration; the system stores the user's information to database after authentication; at the same time, the system allocates a unique ID number to the user to identify the user in the system.

The user can build his own electronic name card case through the mentioned exchange service, which sometimes needs the authorization from the opposite side.

According to the above technical scheme, the mentioned query service includes at least the following steps:

The user dials a special service telephone number to request the service of query;

After verification of the user's identification, the system asks the user for key word of the query;

The system does the query with the key word in the local database;

If no matching record, the system will link to the central database and redo the query with the key word.

According to the above technical scheme, the mentioned modification service includes at least the following steps:

The user dials a special service telephone number to request the service of modification;

The system verifies the user's identification;

The user modifies the personal information and submits the modified form of personal information to the central database;

If the new data is accepted, the central database updates the user's record, and distributes the updated record to every local database in which the user's information is stored;

The local databases are updated in real time.

According to the above technical scheme, the mentioned exchange service includes at least the following steps:

The user dials a special service telephone number to request the service of exchange;

After verifying the user's identification, the system asks user for the query key word of the opposite side with whom the exchange will be conducted;

The system quires local database about whether there is a matching record of the electronic name card of the opposite side. If yes, then the client will submit a transaction request of local exchange for electronic name card to the local server, and the local server will forward the request of local exchange transaction to the central server simultaneously;

The local server accepts the transaction request submitted by the client, and invokes local exchange process to deal with the transaction. At the same time, the central server accepts the transaction request submitted by the local server and invokes the exchange process of electronic name card to deal with the transaction;

If there is no matching record of electronic name card in the local database, then the system is linked to the central database and will redo the query using the query key word. If there is a matching record of electronic name card in the central database, then the local server will submit the transaction request of difference area exchange for electronic name card to the central server. The central server accepts the request from the local server and invokes the exchange process of electronic name card to deal with the transaction.

According to the above technical scheme, the fast call service mentioned includes at least the following steps:

The user dials a special service telephone number to request the service of fast call;

After verifying the user's identification, the system asks user for the query key word of the opposite side with whom the call will be conducted;

A matching record is queried in the local database with the query key word. If there is a matching record, the user's telephone will be switched to the telephone number in the matching record, so that the user can communicate directly with the desired party corresponding to the record.

An electronic name card (ENC) system implementing the above method of the invention includes at least a central transaction processing server linked with a central database system and several local transaction processing servers linked with local database systems. The central transaction processing server connects with the local transaction processing servers through the computer network. The public telecommunication network is connected with the ENC system through the local transaction processing server.

Both of the central database and the local database are all distributed system architecture.

The mentioned central database system can run on the Internet, the real time synchronization between the central database system and the local database system can be implemented through Internet.

The electronic name card provides a brand new and convenient way of communications so that the user can keep contact with all of the members recorded in the electronic name card case without manual input or remembering the telephone number of the other side. This is a special characteristic which is different from all the current ways of communications. Furthermore, although the electronic name card are same as the traditional name card, they record the user's personal information. But the information carrier of the former is paper, while the information carrier of the latter is storage equipment of electronic information, such as database etc., so that the information can be copied and exchanged more conveniently.

The benefits of the electronic name card are as follows:

1. The traditional name card case or address book can be replaced by the electronic name card, the user can inquire his electronic name card anywhere and at anytime to communicate with the opposite side. The electronic name card will never possibly be lost and used more conveniently.

2. It can substitute most of the address programs in the current computer. (a) the electronic name card case is created automatically saving the tedious manual input; (b) when any person information recorded in the electronic name card case changes, the user's electronic name card will update synchronously and immediately, so that failure to keep contact with the opposite side because of the changing information can be avoided; (c) with only one electronic name card case user can manage all of his communication addresses. The electronic name card case has interfaces to connect with application programs, so that the user can transmit the duplicate of the electronic name card case to computer or PDA and send fax or mail etc. conveniently.

3. It is convenient to use ENC as easy as general telephone without any professional skills. The user needs only to memorize the access number of the electronic name card service provider (e.g. it is very easy to memorize a number like 114). By dialing the special number, it is convenient to do the followings:

(1) get the communication number of friends;

(2) inquire about the business/personal information of friends;

(3) put through the opposite side by the service provider to make a call;

(4) call the opposite side by the service provider and leave a message;

(5) modify and update his own personal/business information, and notify all the friends immediately.

### THE DRAWINGS

FIG. 1 is a flow chart for registration of ENC new user.

FIG. 2 is a schematic flow chart of the ENC user information update.

FIG. 3 is a schematic flow chart of the ENC user exchange.

FIG. 4 is a schematic flow chart of the difference area exchange of the ENC user.

FIG. 5 is a schematic flow chart of the ENC user query.

FIG. 6 is a schematic flow chart of the ENC user fast call.

FIG. 7 is a schematic diagram of the physical structure of the ENC system.

FIG. 8 is a schematic diagram of the topological structure of the ENC system.

FIG. 9 is a schematic diagram of the ENC system software with three layer structure.

### DETAILED DESCRIPTION OF THE INVENTION

The invention will be described in detail with reference to the embodiments and drawings.

Electronic name card (ENC), like traditional name card, is used to record the personal information of the user. Through it, the user's identification can be found out and the user can be got in touch. ENC is a summation of the user's personal information marked by the user's ID. The implementation of ENC is by means of the database in the telecommunications system to set up the virtual electronic name card with the summation of the user's personal information marked by the user's ID. ENC provides the traditional communication users, such as telephone and handset, with a brand new communication way of service. Users can use current telephone network by dialing the special telephone number (e.g. 98998), to create, exchange, inquire ENC and communicate with the desired party.

To use ENC service, first users need to register and apply for the service at the ENC service provider. Users fill in their own personal information, and then submit to the ENC system. After validation, the ENC system will save the user information in its own database and allocate the user a unique ID number to identify the user in the system. The application can be made by filling in the registration sheet, and then making a form by manual input, the application can also be made by filling in the form on-line at ENC terminal and then submitting it to the ENC central database.

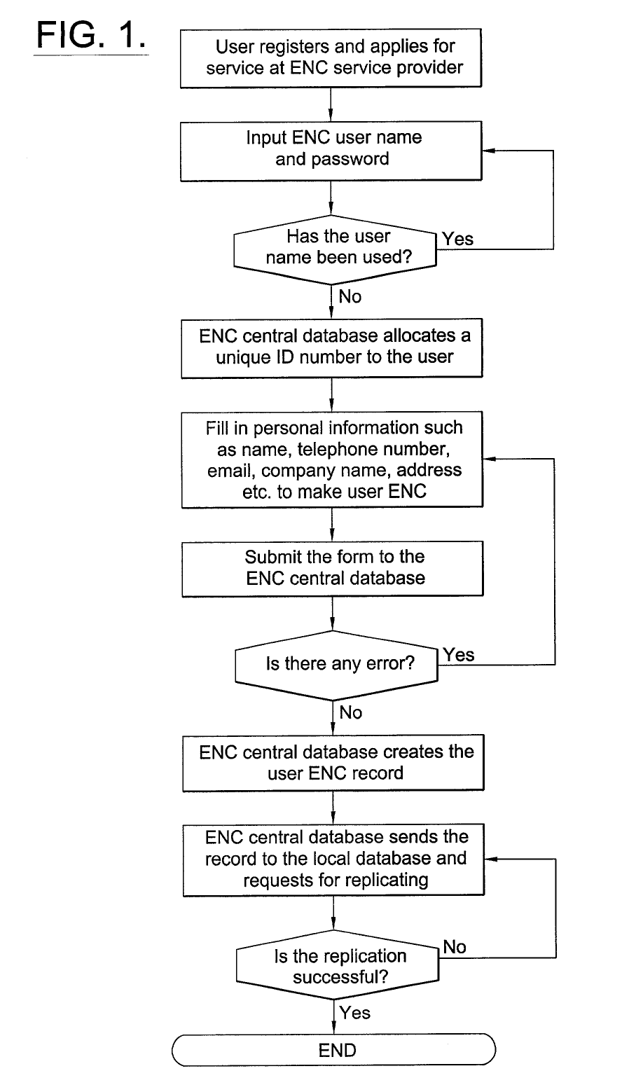

As seen in FIG. 1, this is a flow chart for registration of ENC new user. To apply for ENC service, first the user proposes application to the ENC service provider, inputting the name and password of ENC user. If the name of ENC user has not been used by others in the system, the system will allocate the user a unique ID number. Then the user makes his electronic name card, fills in the user's personal information including true name, telephone number, E-mail address, and the name and address of the company etc. After filling the form, it will be submitted to the ENC central database which will check the submitted form, if no mistake, then the ENC central database will create electronic name card record for the user. The system differentiates the different records by the user's ID number. At the same time, the ENC central database sends the record to the local database at the ENC service provider and requests the local database to copy the record, if this copy is successful, the registration procedure for service is finished.

After the registration procedure is finished, the personal information form is filled in and accepted by the ENC database, the user will get his own electronic name card. The electronic name card is a generic terms for the user's personal information marked by the user's ID.

ENC electronic name card can include business name card and personal name card, they can also include multimedia information and common information form, etc. what shows in Table. 1 is only an example of information definition form of database for business name card. It may vary depending upon the circumstances.

TABLE 1
Information Table of Business Name card

| Field | Name of field | | |
|---|---|---|---|
| S/N | (COLUMN NAME) | Data Type | Note |
| 1. | UserID | Int | User ID Number |
| 2. | Name1 (FirstName) | varchar (20) | Chinese Name (English |
| | | | Surname) |
| 3. | Name2 (SecName) | varchar (20) | (English Name) |
| 4. | Company | varchar (60) | Name of Company (30 |
| | | | Chinese characters) |
| 5. | CompanyFieldCode | Int | Code of Company |
| | | | Domain |
| 6. | DepartmentCode | Int | Code of Company |
| | | | Branch |
| 7. | Title1 | varchar (16) | Title 1 (8 Chinese |
| | | | characters) |
| 8. | Title2 | varchar (16) | Title 2 (8 Chinese |
| | | | characters) |
| 9. | Website | varchar (50) | Website URL (50 |
| | | | characters) |
| 10. | BizEmail | varchar (50) | Business e-mail: a@b |
| | | | (a < 16, b < 30) |
| 11. | Phone1 | varchar (15) | Phone 1 (15 bit) |
| | | | (*extension number) |
| 12. | Phone2 | varchar (15) | Phone 2 (15 bit) |
| | | | (*extension number) |
| 13. | Phone3 | varchar (15) | Phone 3 (15 bit) |
| | | | (*extension number) |
| 14. | Phone4 | varchar (15) | Phone 4 (15 bit) |
| | | | (*extension number) |
| 15. | Fax1 | varchar (10) | Fax 1 (10 bit) |
| 16. | Fax2 | varchar (10) | Fax 2 (10 bit) |
| 17. | Fax3 | varchar (10) | Fax 3 (10 bit) |
| 18. | Mphone | varchar (15) | Mobile phone (15 bit) |
| 19. | Beeper | varchar (20) | Pager: a-b (a < 10, |
| | | | b < 10) |
| 20. | BeeperType | Bit (1) | Type of Pager: |
| | | | Chinese (=1/ |
| | | | Numeric (=2) |
| 21. | BeeperAuto | varchar (20) | Auto Calling Method |
| | | | (20) |
| 22. | AreaCode | char (6) | ZIP Code (6 bit) |
| 23. | PostCode | char (6) | Post Code of Company |
| | | | (6 bit) |
| 24. | Address1 | varchar (40) | Address 1 of Company |
| | | | (20 Chinese Characters) |
| 25. | Address2 | varchar (40) | Address 2 of Company |
| | | | (20 Chinese Characters) |
| 26. | DefaultCallCode | Int | Code of Default Com- |
| | | | munication Mode |
| 27. | CompanyCityCode | Int | Code of City Where |
| | | | Company is located |
| 28. | CompanyProvinceCode | Int | Code of Province Where |
| | | | Company is located |
| 29. | CompanyCountryCode | Int | Code of Nation, Default |
| | | | No (No Input Interface) |
| 30. | EnableSearching | Bit (1) | Whether or not search- |
| | | | able (Y/N) |
| 31. | SwitchOption | Bit (1) | Mode of Exchanging |
| | | | Name Card (Authorized/ |
| | | | At will) |
| 32. | BizcardCreation | Bit (1) | Whether or not business |
| | | | name card have been |
| | | | made (Y/N) |

The function of electronic name card is the same as that of general name card, used for marking the user's personal information, exchanging with the other side and keeping contact between each other. The difference between them lies in: electronic name card are digital information record stored in the database of computer; traditional name card are traditional presswork in which the carrier is common paper. It is apparent that ENC has obvious predominance over the traditional name card in the aspects of query, update, replication and distribution, etc.

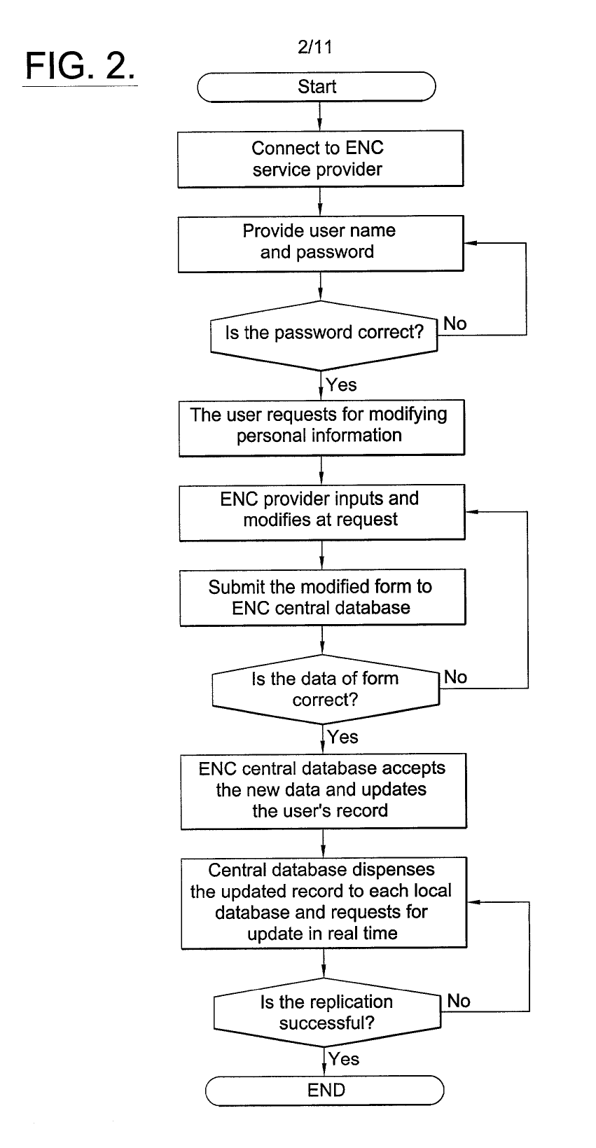

When the NEC user's personal information (such as number of phone or handset) changes, the user's record in the ENC database becomes out of date, the user needs to update it to ensure the information correct. As seen in FIG. 2, a flow chart of updating ENC user's information, the procedures are as follows:

1) When ENC user find out that some information should be updated, he can dial the number of ENC provider and request for updating some of his own personal information. (He can directly go to ENC service provider to handle, also).

2) After ENC service provider verifies the user's identification (password verification), the user's ID number is inputted, the user's personal information is extracted from the ENC database and displayed on the information query interface of computer (the interface is similar to that of Table 1).

3) ENC service provider, at the user's request, modifies his personal information and refills in the personal information form.

4) After the form modification finished, it will be submitted to the ENC central database. If no error, the renewed user's information will be written into the database to update the user's record.

5) ENC central database (on Internet) dispenses the updated user information to every ENC local database (at the service provider) in which the user information is stored and requests these local databases to be updated in real time.

6) If the above operations are successful, the hit message will return and the procedure is finished.

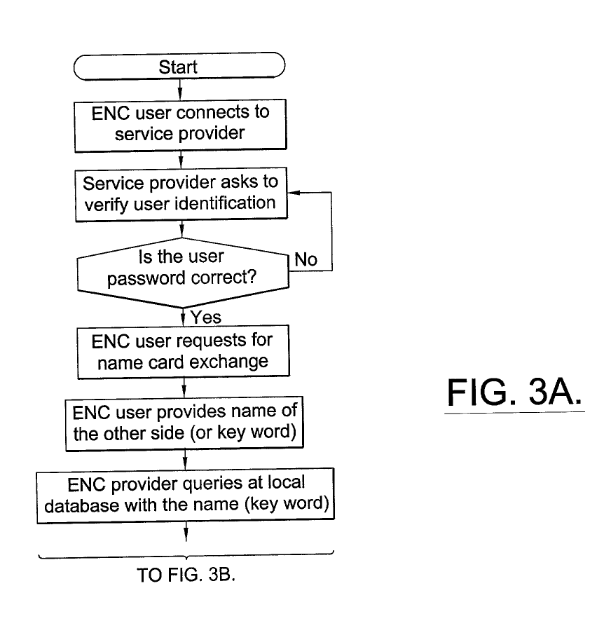

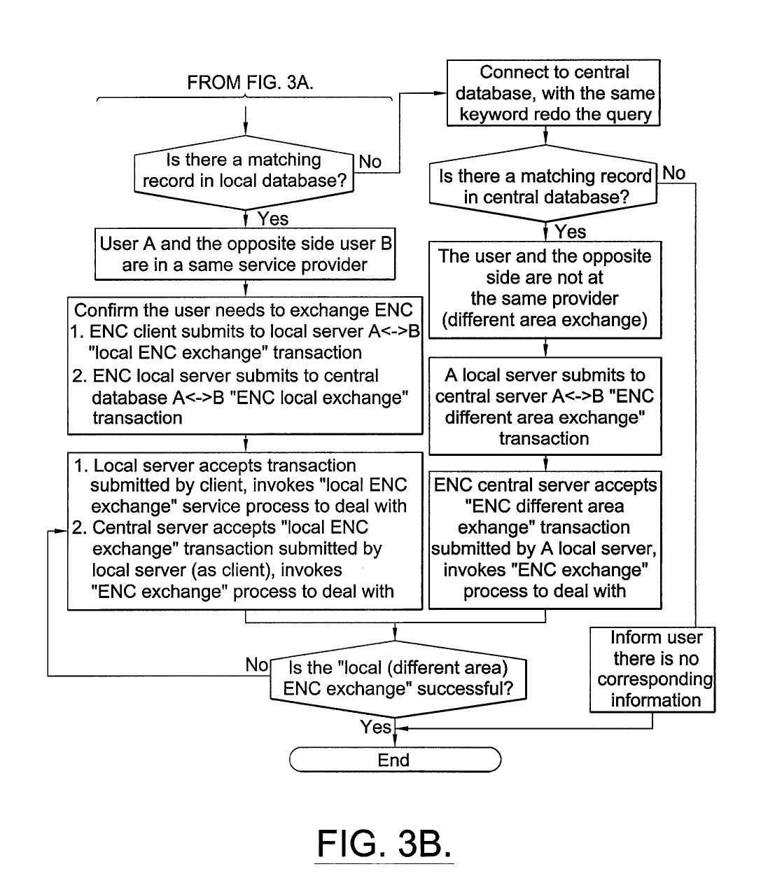

When ENC user gets the other user information about the electronic name card ID number, name and company name, etc., through his own ENC service provider, he can exchange cards with the other side. As seen in FIG. 3, the procedures are as follows:

1) If the user needs to exchange electronic name card with a friend, he can dial the number of ENC service provider and request the service of exchanging name card.

2) After ENC service provider verifies the user's identification (password verification), the user's ID number is inputted and the application program for exchanging name card is started.

3) ENC service provider requests for query key word, such as ID number, name, etc, and does query firstly in the local database using the key word.

4) If a matching ENC record is found in the local database, then it is determined that the other side and the user are located at the same ENC service provider. The ENC provider asks the user whether or not he hopes to exchange ENC with the other side: if the user abandons, then quit; if the user verifies the exchange, then the ENC local exchange procedure is started. If the other side requests the name card exchange must be authorized. It is only after getting the authorization from the other side, the ENC exchange service can be finished successfully.

5) If no matching ENC record is found in the local database, then the provider sends the query request to the ENC central database with the same key word.

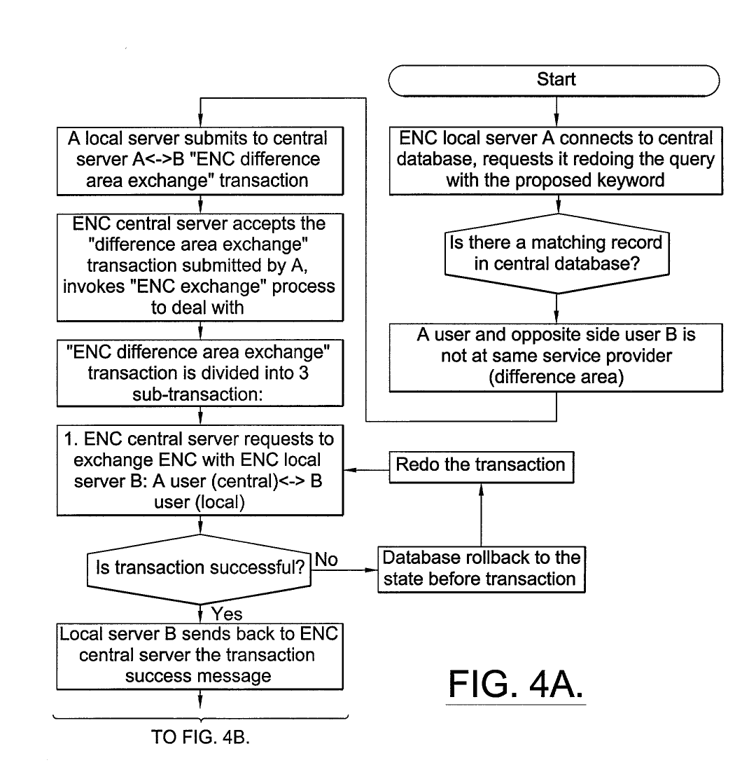

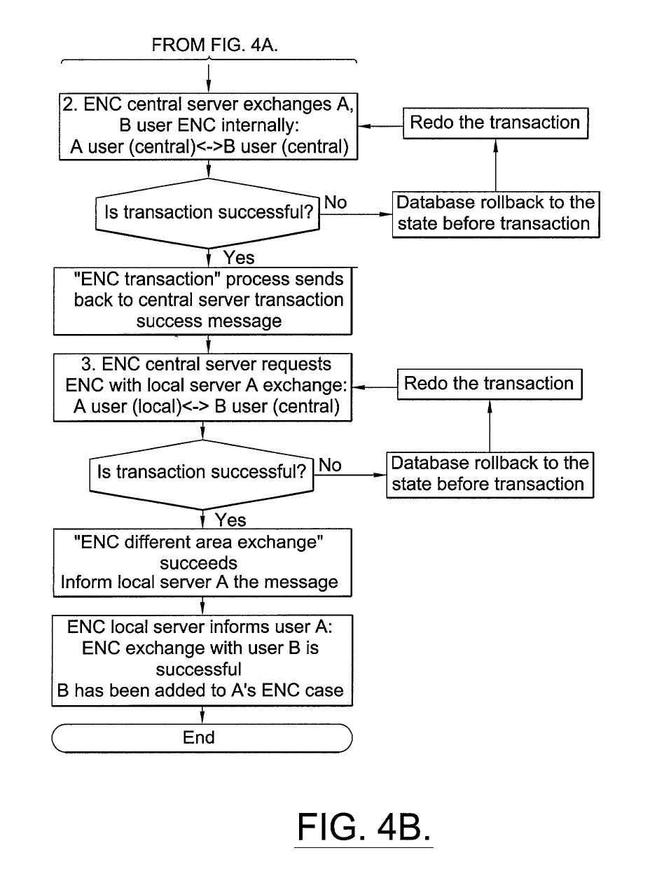

6) If matching ENC record is found in the central database, then it is determined that the user and the other side does not belong to the same ENC service provider. The provider asks the user whether or not he hopes to exchange ENC with the other side: if the user abandons, then quit; if the user verifies the exchange, then the ENC exchange procedure with difference area is started. The procedure is seen in FIG. 4. If the other side requests name card exchange must be authorized. Then only after getting the authorization from the other side, the service of ENC exchange can be finished successfully.

7) If no matching ENC record is found in the central database, then the provider notifies the user there is no name card for exchange.

8) The provider asks the user whether or not he hopes to continue the service of exchange, if yes, it goes back to step 3, otherwise, the procedure of ENC exchange service is ended.

After registering as a user of ENC system, the user can create his own electronic name card case. If the other side, who the user hopes to save in his name card case, is also a registered user in ENC, by knowing the information of ID number etc. of the other side, the user can, through ENC system, add the other side into his own electronic name card case. Naturally, sometimes an authorization from the other side is needed.

The system distinguishes the electronic name card case of different users through users' ID. The creation of name card case is automatic through the above exchange procedure of the electronic name card. The exchange procedure is similar to the traditional name card exchange in the form. It is more advanced and convenient because of its basis of digital information technology.

ENC name card case can have many types, such as business name card case, friend name card case, relative name card case, and classification table of name card case. See Table 2 of business name card case, Table 3 of friend name card case, Table 4 of database definition information sheet for classification table of name card case. They may vary depending upon the circumstances.

TABLE 2
Business Name card Case

| Column | | | |
|---|---|---|---|
| No | Column Name | TYPE | Note |
| 1 | UserID | Int | User ID number |
| 2 | FriendUserID | Int | Friend ID number |
| 3 | SubCategoryCode | Int | Category Code |
| 4 | Status | Int | Status(0 normal, 1 re- |
| | | | cycle bin, 2 deleted) |
| 5 | FriendName1 | Varchar | Name of friend (English |
| | | (20) | name) |
| 6 | FriendName2 | Varchar | (English Surname) |
| | | (20) | |
| 7 | F_Company | Varchar | Name of friend's |
| | | (60) | company |
| 8 | F_CompanyFieldCode | Int | Code of friend's |
| | | | company field |
| 9 | F_CompanyProvinceCode | Int | Code of province where |
| | | | friend's company is |
| | | | located |
| 10 | F_CompanyCityCode | Int | Code of city where |
| | | | friend's company is |
| | | | located |
| 11 | F_CompanyCountryCode | Int | Code of state where |
| | | | friend's company is |
| | | | located |
| 12 | F_DefaultCallCode | Int | Code of default call |
| | | | mode (with default mode |
| | | | of other side changed, |
| | | | dynamic modification is |
| | | | triggered) |
| 13 | Remark | Varchar | Memo (50 Chinese |
| | | (100) | characters) |

TABLE 3
Friend Name card Case

| Column | | | |
|---|---|---|---|
| No | Column Name | TYPE | Note |
| 1. | UserID | Int | User ID number |
| 2. | FriendUserID | Int | Friend Id number |
| 3. | FriendType | Int | Type of friend (0/general, |
| | | | 1/good friend) |
| 4. | SubCategoryCode | Int | Category Code |
| 5. | Status | Int | Status (0 normal, 1 recycle |
| | | | bin, 2 deleted) |
| 6. | FriendName1 | Varchar | Name of friend (English |
| | | (20) | name) |
| 7. | FriendName2 | Varchar | (English surname) |
| | | (20) | |
| 8. | F_PenName | Varchar | Pen name of friend |
| | | (40) | |
| 9. | F_PersonProvinceCode | Int | Code of province where |
| | | | friend lives |
| 10. | F_PersonCityCode | Int | Code of city where friend |
| | | | lives |
| 11. | F_PersonCountryCode | Int | Code of state where friend |
| | | | lives |
| 12. | F_DefaultCallCode | Int | Code of default call mode |
| | | | (with the default call mode |
| | | | of other side changed, |
| | | | dynamic modification is |
| | | | triggered) |
| 13. | Remark | Varchar | Memo (50 Chinese |
| | | (100) | characters) |

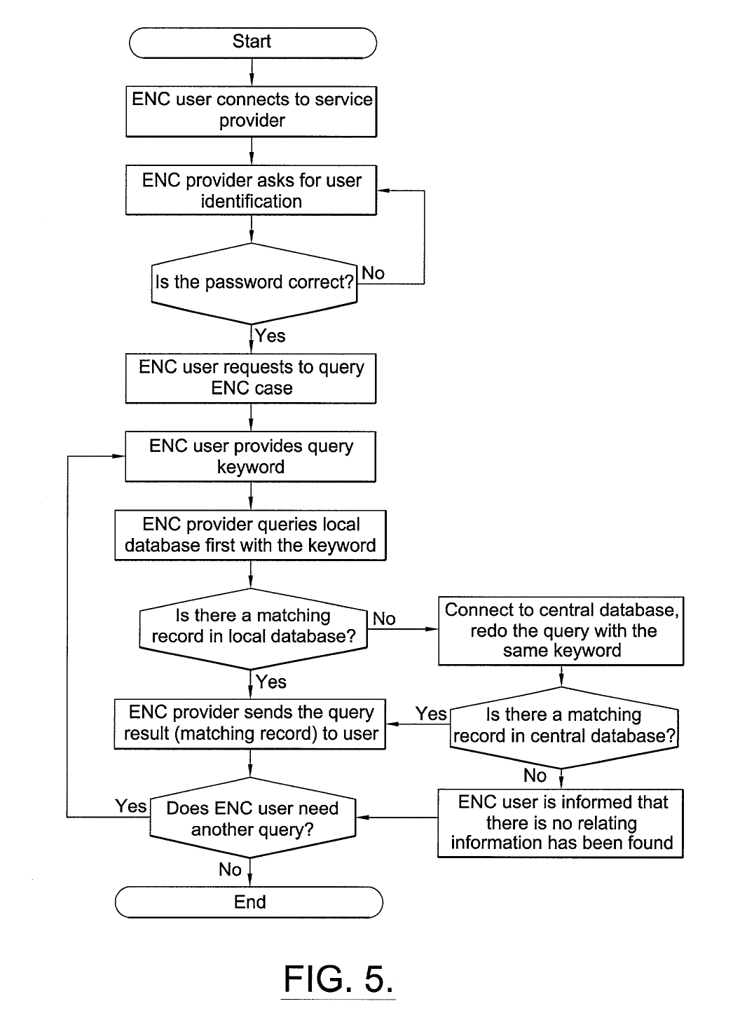

TABLE 4
Name card Case Classification

| Column | | | |
|---|---|---|---|
| No | Column Name | TYPE | Note |
| 1. | UserID | Int | User ID |
| 2. | Category | Int | Category (1/business, 2/good |
| | | | friend, 3/friend, 4/member card) |
| 3. | SubCategoryName | Varchar | Name of category (10 Chinese |
| | | (20) | characters) |
| 4. | SubCategoryCode | Int | Code of category |
| 5. | Status | Int | status (0 normal, 1 recycle bin, 2 |
| | | | deleted) |

Wherever ENC user is, whenever he hopes to contact with a friend or know the relevant information about the friend, he can dial the number of the ENC service provider and get the needed information by using the query service of electronic name card case. As seen in FIG. 5, the procedures of query service are as follows:

1) If the user needs to know the personal information about a friend, he can dial the number of the ENC service provider and request for inquiring about his own electronic name card case.

2) After the user's identification is verified (password verification), the provider starts the query program of electronic name card case, inputs the user's ID number and enters the user interface of electronic name card case.

3) The provider requests for query key word from the user and does the query firstly in the local database by using the key word.

4) If a matching record is found, then the provider notifies the user the information in the matching record.

5) If no matching record in the local database, then the provider sends the query request to the ENC central database with the same key word.

6) If a matching record is found in the ENC central database, then the provider notifies the user the information in the matching record; if no matching record in the ENC central database, then the provider notifies the user that relevant information has not been found.

7) The ENC service provider asks the user whether or not he hopes to continue the query procedure, if yes, then goes back to step 3, otherwise, the query procedure is ended.

Wherever ENC user is, whenever he hopes to call a friend, he may dial the number of the ENC service provider and get in touch with the opposite side to make a call by using the service of fast call. Compared with the existing communication way of telephone, ENC users needn't search in a pile of name card any more, and it is also not necessary to input long number of phone or handset. The communications procedure becomes more simple and convenient.

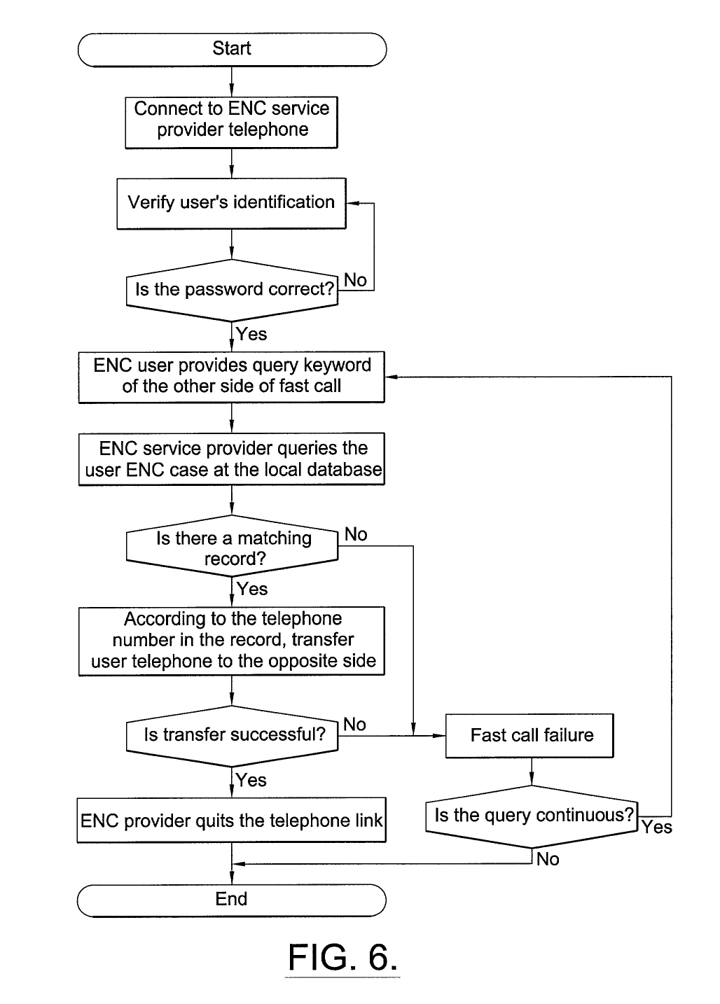

As seen in FIG. 6, the procedures of the ENC service of fast call are as follows:

1) When the user needs to call the other side, he may dial the number of the ENC service provider and request the service of fast call.

2) After verification of the user's ID (password verification), the ENC service provider starts the fast call program, inputs the user's ID number and enters the user interface of electronic name card case.

3) The ENC service provider does query in the local database with the key word, such as person's name, nick name or name of company, provided by the user.

4) If no matching record in the local database, it shows that fast call has failed, then the ENC service provider asks the user whether or not he hopes to continue the service; if yes, then goes back to step 3; if no, then the service quits, and the phone will hang up.

5) If a matching record is found, then the ENC service provider try to transfer the call of the ENC user to the other side according to the number (handset, pager) in the matching record.

6) If the call to the other side is put through successfully, it shows that the ENC service provider has successfully established the circuit connection between the user and the other side, then the service will be ended. ENC will quit the circuit connection, hang up his phone, but keep the communication between the user and the other side.

7) The procedure of fast call is ended.

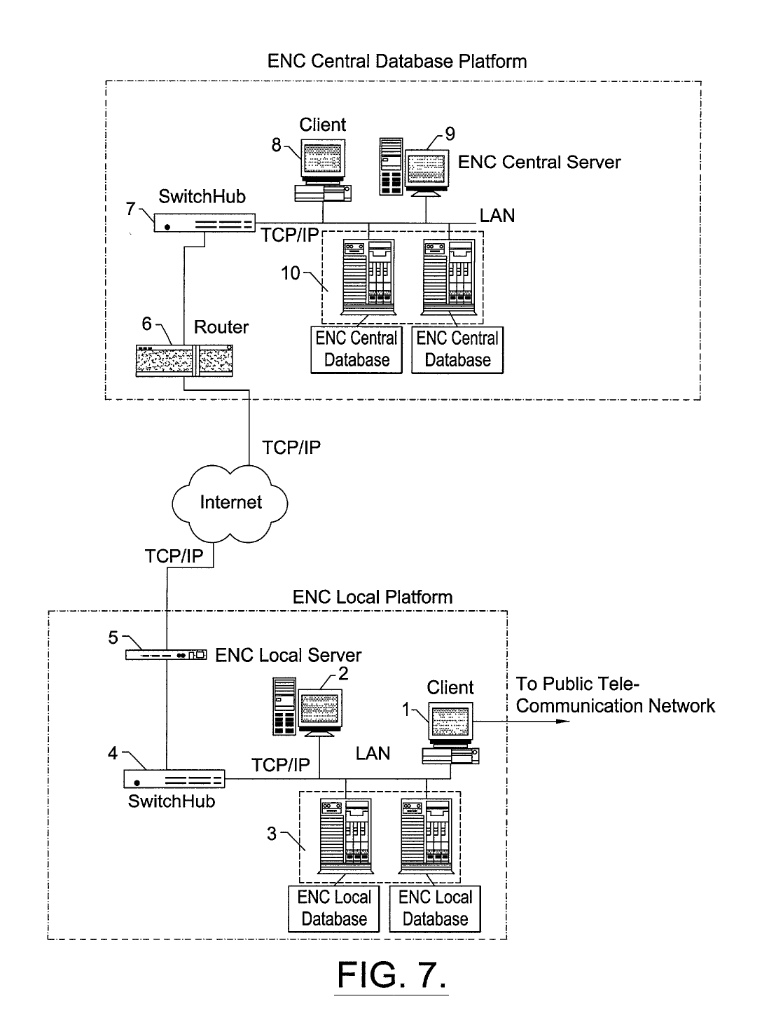

As seen in FIG. 7, the ENC system implementing the ENC functions mentioned above includes at least a central transaction processing server 9 and several local transaction processing servers 2. The central transaction processing server 9 connects with the central database system 10 and the local transaction processing servers 2 connect with the local database systems 3. The central transaction processing server connects with the local transaction processing server through the computer network. The public telecommunication network is connected with the ENC system through the local transaction processing server. Wherein, both the central database and the local database are distributed system architecture. The central transaction processing server may be connected with local transaction processing server though Internet. The mentioned central database system can run on the Internet, the real time synchronization between the central database system and the local database system can be implemented through Internet.

When there is a request for the service of ENC, through the client ENC system sends the user transaction request including query, information update and ENC name card exchange etc. to the service-processing server. After the transaction request is submitted from client 1 to transaction server 2, the transaction server will invoke corresponding service processes at the server end to operate the database. Database server 3 executes the operation request from the transaction server 2. The query result (RecordSet) will return from the database server 3 to the transaction server 2 and then to the ENC user through public telecommunication network.

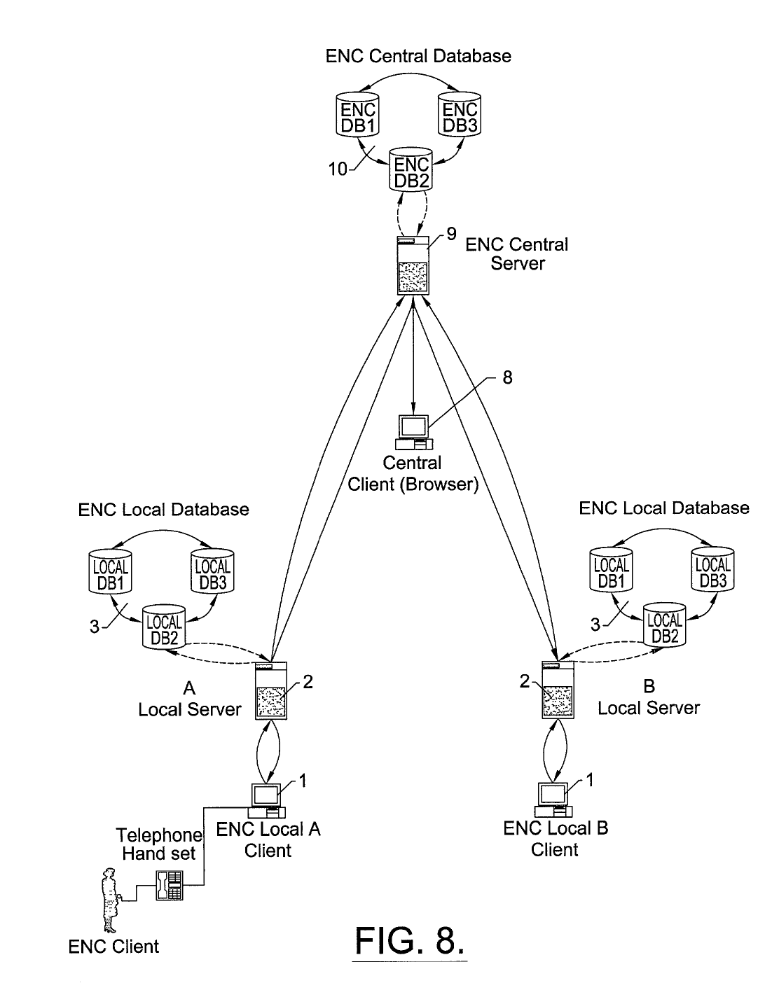

The whole structure of the ENC system is showed in FIG. 8. It is the architecture of “distributed database +three-layer structure”.

“Distributed database” refers to the structure of the ENC database system. The ENC system is composed of a central database storing all the ENC users' records and several local databases, which locate at each ENC service provider, storing only the users records of that provider. That is, each ENC local database is a subset of the ENC central database, and there are no overlapped records among the subsets.

The purpose of using distributed database is that most of the query and fast call services can be completed locally and rapidly through the operation of local database, in order to provide high performance to satisfy the user need. If all the queries are done in the ENC central database, it will result in the problems, such as system overloaded, network congestion, database lock and system crash etc.

When the record in the central (local) database changes, the local (central) database must ensure a real time, bi-directional and synchronous change to keep information consistency both in the ENC central database and local database. The ENC system ensures the information consistency by transaction processing.

“Three-layer structure” refers to the method of transaction processing. The system is divided into: presentation layer, i.e. client; business logic layer, i.e. transaction server; data layer, i.e. database server. It can be seen from the drawing that either ENC center 8, 9, 10 or ENC local provider 1, 2, 3 adopts the three-layer structure as basic architecture, that is client ⇄ transaction server ⇄ database server.

It is noted that the concept of client and transaction server is not absolute. For example, when ENC local provider needs to query about information in the ENC central database (if the user needs some uncommon information that is not stored in the ENC local provider), the ENC local transaction server is a client at this time. It sends the transaction request to the ENC central transaction server, and asks the ENC central transaction server responses the request and returns result (RecordSet) to the ENC local transaction server. When updates take place in the ENC central database and it is necessary for the ENC local database to update synchronously, the ENC central transaction server is a client at this time, it sends the transaction request to the ENC local transaction server, and asks the ENC local transaction server responses the request and returns the updating result message, success or failure, to the ENC central transaction server.

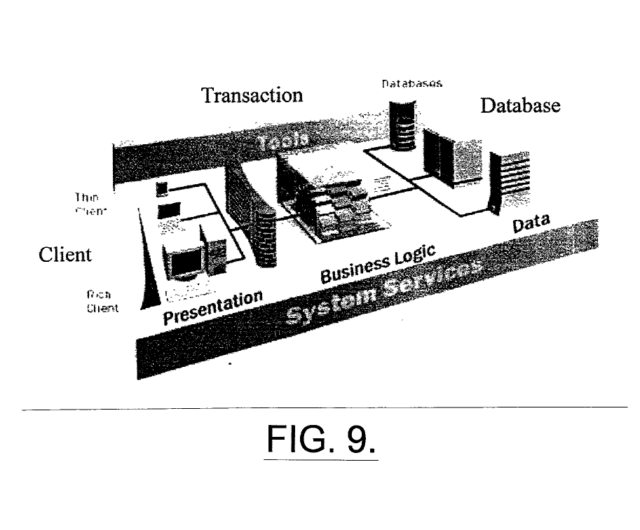

The software of the ENC system is showed in FIG. 9. It is three-layer software architecture oriented to the transaction processing.

The first layer is presentation layer, which is a user-machine interface layer, used by the client to receive the user event request, send the transaction request to the server and display the result returned from the server to the user. Taking a real system based on Microsoft DNA technology as example, the client can be MS IE5.0 browser running on Windows 98, the presentation layer here is the HTML web page displayed in the IE browser to the user. Browser receives the user's request by HTML form, submits the request to the web server and displays the HTML pages returned from the server.

The second layer is business logic layer. It is a transaction-processing layer, that is used for receiving the transactions submitted from the client, calculating according to the predefined conditions of the business logic and transaction, doing query in the database. It ensures the transaction complete and successful, and returns the operation result to the client. For instance, when transaction server, running on the service end, receives the transaction request submitted by browser through web server, it will invoke the corresponding transaction processing process to do the calculation and query in the database. Then, it will transfer the result of query and calculation, by transforming it into HTML pages, to the browser. Taking the above real system based on Microsoft DNA technology as example, where Microsoft Transaction Server (MTS), used as transaction-processing server, receives the transaction request submitted by IE browser through Internet Information Server (IIS), WWW server. MTS will invoke the corresponding service process component (COM) to do the service, to query in the database, and will return the result, by transforming it into HTML page to IE browser.

The third layer is data layer, i.e. database. It is used to receive the query request transmitted from the transaction processing server, search in the database according to the query conditions, and return the matching record (RecordSet) to the transaction server. Taking also the above real system based on Microsoft DNA technology as example, where SQL server database receives the query request that comes from MTS by invoking the COM component. Then it will do the query in the database by using structure query language (SQL) or invoking stored procedure and return the record set to the MTS.

The method of the above transaction processing will be further described by taking the software function of the exchange service of ENC name card as an example.

Exchanging ENC name card, i.e. user A requests for exchanging name card with user B, will have finished by a series of database operations. For example, in the software system of database, the procedure of exchanging name card between user A and B can be implemented by the following operations:

1. Taking the user B's information field from the database;

2. Adding a new record in the user A's electronic name card case, TABLE;

3. Storing the user B's information field into the corresponding field of user A's new record;

(Through the above steps, user B has been added in the user A's electronic name card case.)

4. Through the same steps as above 1˜3, user A can also be added in the user B's electronic name card case.

The action of the above serial operations, used to finish a concrete event, is called “Transaction”. The characteristic of transaction processing is “all is done” or “all is undone”, that is to say, in the exchange service of ENC name card, only when the above four steps of database operations are totally successful, then the exchange transaction is successfully, and all the databases are updated. If there is a failure in any one of the four steps, the failure message returns immediately, and the exchange transaction of ENC name card is failed. All databases will scroll back to the initial states before the transaction starts, and i.e. all the databases are not updated.

The procedure of software processing for the different area exchange transaction of ENC name card is as follows:

ENC name card exchange transaction is divided into three small transactions to implement, i.e.

1. ENC central server requests for exchanging ENC with ENC local server B; User A (central)⇄User B (local)

2. ENC exchange between user A and B takes place inside the ENC central server; User A (central)⇄User B (central)

3. ENC central server requests for exchanging ENC with ENC local server A; User A (local)⇄User B (central)

The implementation of above 1-3 steps is a series of access operations in database. Taking step 1 as an example, user A in central database exchanges ENC with user B in local database:

1. Reading out user B's record (column value) from the local database;

2. Adding a new record in table of user A's ENC name card case in the central database;

3. Writing the user B's information fields, which come from the local database B, into the corresponding fields of user A's new record in the central database;

4. Reading out user A's record (column value) from the central database;

5. Adding a new record in table of user B's ENC name card case in the local database;

6. Writing the user A's information fields, which come from the central database, into the corresponding fields of user B's new record in the local database.

If the above six steps of database operations are finished successfully, the function will return a successful message, then the exchange transaction processing between user A (central) and user B (local) will be completed successfully. Otherwise, if there is failure in any one of the above steps, the operation function will return failure message, it means that the transaction processing failed; database will scroll back to the initial states before the transaction processing starts. Apparently, only when all three small transaction are finished in order, the exchange transaction of ENC name card will be successful. Otherwise failed, all has not been done. This is the method of transaction processing for implementing ENC name card exchange. In the whole ENC software system design, this design idea is carried out all the time.

When the invention is implemented in the telecommunications network, it is more convenient to use intelligent network mode with a new intelligent business service. Other modes, such as intelligent platform or calling center may also be adopted. They are only different implementation mode and should be fallen into the protection scope defined by the invention.

The above descriptions, which are the preferred embodiments of the invention, should not limit the invention. Any modification, equivalent substitution, improvements etc, within the spirit and principle of the invention, should be included in the claims of the invention.

1. A method for implementing the service function of electronic name card in the telecommunication system, wherein it is characterized that the method includes at least:
Establishing virtual electronic name card with a summation of user's personal information marked by user's ID in the form of database in the telecommunications system;
By dialing a special telephone number so that user can request electronic name card services including query, modification, exchange, and fast call:

2. The method of claim 1 wherein it is characterized that: the said establishment is implemented by user registration and application for the services of electronic name card;
It is included that user fills in the personal information when registration; after verification, the system writes down the user's information into the database and allocates the user a unique ID number to identify the user in the system.

3. The method of claim 1 wherein it is characterized that: the user can create his own electronic name card case through the said exchange service.

4. The method of claim 1 or 3 wherein it is characterized that: the said exchange service must be further authorized by the other side to be exchanged with.

5. The method of claim 1 wherein it is characterized that the said query service includes at least the following steps:
The user dials a special telephone number to request a query service;
After verifying the user's identification, the system asks the user for query key word;
The system does the query with the key word in the local database;
If no matching record, the system will redo the query with the key word by linking to the central database.

6. The method of claim 1 wherein it is characterized that the said modification service includes at least the following steps:
The user dials a special telephone number to request a modification service;
The system verifies the user's identification;
The user modifies the personal information and submits the modified form of personal information to the central database;
The central database updates the user's record if the new data is accepted, and dispenses the updated record in every local database in which the user's information is stored;
The local database is updated in real time.

7. The method of claim 1 wherein it is characterized that the said exchange service includes at least the following steps:
The user dials a special telephone number to request a service of exchange;
After verifying of the user's identification, the system asks the user for the query key word of the opposite side to be exchanged with;
The system queries local database about whether there is a matching record of the opposite side or not;
If there is a matching record of electronic name card in the local database, then the client will submit a transaction request for local exchange to the local server, at the same time the local server will also submit a transaction request for local exchange to the central server;
The local server accepts the transaction request submitted by client, and invokes local exchange process of electronic name card to deal with the transaction, at the same time, the central server accepts the transaction request submitted by local server and invokes exchange process of electronic name card to deal with the transaction;
If there is no matching record of electronic name card in the local database, then the system is linked to the central database and will redo the query using the query key word, if there is a matching record of electronic name card in the database, then the local server submits a transaction request for difference area exchange of electronic name card to the central server, the central server accepts the transaction request from the local server and invokes exchange process of electronic name card to deal with the transaction.

8. The method of claim 1 wherein it is characterized that the said fast call service includes at least the following steps:
The user dials a special telephone number to request a fast call service;
After verifying the user's identification, the system asks the user for the query key word of the opposite side to be called;
With the query key word, a matching record is queried in the local database, If there is, the user's telephone will be transferred to link with the telephone number in the matching record, so that the user can communicate directly with the desired party corresponding to the record.

9. An electronic name card (ENC) system wherein it is characterized that:
The system includes at least a central transaction processing server and several local transaction processing servers, the central server links with central database system, and the local server with local database system;
The central transaction processing server connects with the local transaction processing server through the computer network, while the public telecommunication network is connected with the ENC system through the local transaction processing server.

10. The system of claim 9 wherein it is characterized that: both the central database and the local database uses distributed system architecture.

11. The system of claim 9 wherein it is characterized that: the said central database system runs on the Internet, the real time synchronization between the central database system and the local database system is implemented through INTERNET.
